(19) United States
(12) Patent Application Publication
(10) Pub. No.: US 2026/0243471 A1
(43) Pub. Date: Aug. 20, 2026

(54) HEAT PUMP SYSTEM AND METHOD FOR MANUFACTURING HEAT PUMP DEVICE

(71) Applicant: Mitsubishi Electric Corporation, Tokyo (JP)

(72) Inventors: Yoji ONAKA, Tokyo (JP); Makoto TANISHIMA, Tokyo (JP); Toshio SHINOKI, Tokyo (JP); Makoto KAWAMOTO, Tokyo (JP); Seiji NAKASHIMA, Tokyo (JP); Tomoya FUKUI, Tokyo (JP)

(73) Assignee: Mitsubishi Electric Corporation, Tokyo (JP)

(21) Appl. No.: 18/876,671

(22) PCT Filed: Jul. 15, 2022
(86) PCT No.: PCT/JP2022/027820

§ 371 Date: Dec. 19, 2024

(51) Int. Cl. F25B 9/00

(52) U.S. Cl. CPC F25B 9/008

(57) ABSTRACT

A heat pump system according to the present disclosure includes a carbon dioxide recovery system configured to recover carbon dioxide from air by using energy; and a heat pump device configured to store at least carbon contained in the carbon dioxide recovered by the carbon dioxide recovery system.

### TECHNICAL FIELD

The present disclosure relates to a heat pump system and a method for manufacturing a heat pump device.

### BACKGROUND ART

Patent Document 1 discloses a CO2 negative emission plant that captures carbon dioxide from an exhaust of a plant in operation and discharges a gas that substantially does not contain the carbon dioxide.

### CITATION LIST

### Patent Documents

Patent Document 1: PCT International Publication No. WO2012/230045

### SUMMARY OF INVENTION

### Problem to be Solved by the Invention

When the captured carbon dioxide is stored underground or the like, long-term management is desirable, and thus significant amounts of effort and energy are required. Patent Document 1 discloses that captured carbon dioxide is used in a botanical plant. However, in Patent Document 1, use of the captured carbon dioxide is limited.

The present disclosure has been made in view of the above-described problems, and an object thereof is to provide a heat pump system and a method for manufacturing a heat pump device, with which use of recovered carbon dioxide can be expanded and carbon dioxide released into the air can be reduced.

### Means to Solve the Problem

An aspect of the present disclosure provides a heat pump system including a carbon dioxide recovery system configured to recover carbon dioxide from air by using energy; and a heat pump device configured to store at least carbon contained in the carbon dioxide recovered by the carbon dioxide recovery system.

Another aspect of the present disclosure provides a method for manufacturing a heat pump device configured to recover carbon dioxide from air by using energy and to store at least carbon contained in the recovered carbon dioxide.

### Effects of the Invention

According to the present disclosure, it is possible to provide a heat pump system and a method for manufacturing the heat pump device, with which use of the recovered carbon dioxide can be expanded and the carbon dioxide released into the air can be reduced.

### BRIEF DESCRIPTION OF DRAWINGS

FIG. 1 A block diagram showing a heat pump system according to Embodiment 1.

FIG. 2 A block diagram showing a heat pump system according to Embodiment 2.

FIG. 3 A block diagram showing a heat pump system according to Embodiment 3.

FIG. 4 A block diagram showing a heat pump system according to Embodiment 4.

FIG. 5 A block diagram showing a heat pump system according to Embodiment 5.

FIG. 6 A block diagram showing a heat pump system according to Embodiment 6.

FIG. 7 A schematic diagram showing a schematic configuration of a heat pump device included in a heat pump system according to Embodiment 7.

FIG. 8 A block diagram showing a heat pump system according to Embodiment 8.

FIG. 9 A schematic diagram showing a schematic configuration of a heat pump device included in a heat pump system according to Embodiment 9.

FIG. 10 A schematic diagram showing a schematic configuration of a heat pump device included in a heat pump system according to Embodiment 10.

FIG. 11 A block diagram showing a heat pump system according to Embodiment 11.

### DESCRIPTION OF EMBODIMENTS

Hereinafter, embodiments of the present disclosure will be described with reference to the drawings. It should be noted that the scope of the present disclosure is not limited to the following embodiments and can be changed in any way within the scope of technological ideas of the present disclosure.

### Embodiment 1

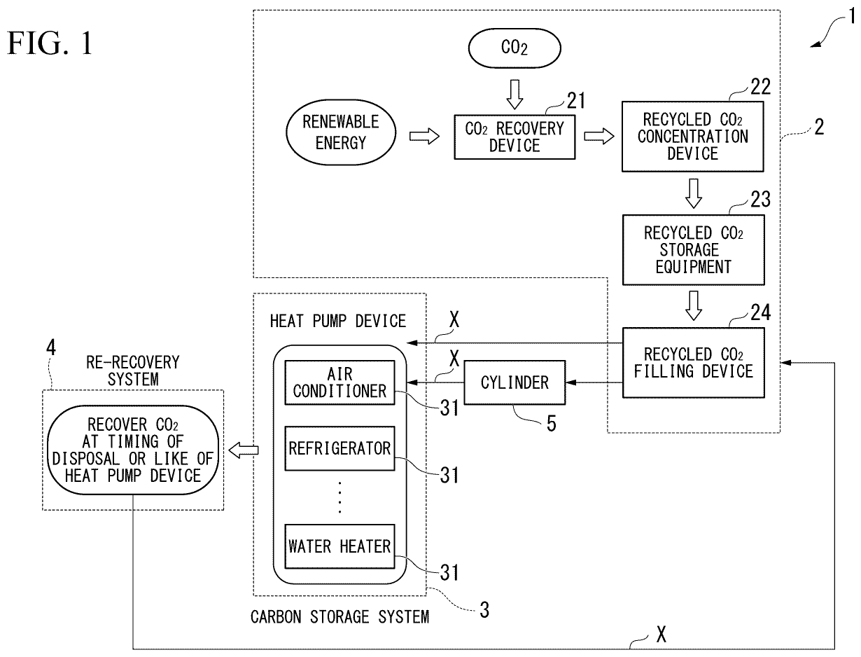

FIG. 1 is a block diagram showing a heat pump system according to Embodiment 1. As shown in FIG. 1, the heat pump system 1 according to Embodiment 1 includes a carbon dioxide recovery system 2, a carbon storage system 3, and a re-recovery system 4.

The carbon dioxide recovery system 2 recovers carbon dioxide (CO2) from the air by using energy. For example, the carbon dioxide recovery system 2 recovers the carbon dioxide from the air by using renewable energy. The renewable energy is, for example, electric power obtained by using solar light, airflow, geothermal power, small and medium hydro power, or biomass. The heat pump system 1 according to the present embodiment 1 may include a device that generates renewable energy. In a case in which the carbon dioxide recovery system 2 uses renewable energy, it is possible to reduce a discharge amount of greenhouse gases.

The carbon dioxide recovery system 2 recovers, for example, carbon dioxide from the air. The air is, for example, outside air. The air may also be indoor air, an exhaust gas from a factory, or the like. That is, the gas from which the carbon dioxide recovery system 2 recovers the carbon dioxide is not limited to the atmosphere.

As shown in FIG. 1, the carbon dioxide recovery system 2 includes a carbon dioxide recovery device 21, a recycled carbon dioxide concentration device 22, recycled carbon dioxide storage equipment 23, and a recycled carbon dioxide filling device 24.

As shown in FIG. 1, the carbon dioxide recovery device 21 is supplied with the air containing carbon dioxide and renewable energy. The carbon dioxide recovery device 21 uses the renewable energy to recover the carbon dioxide from the air. For example, the carbon dioxide recovery device 21 includes a fan operated by the renewable energy. Further, the carbon dioxide recovery device 21 includes a separation device that separates the gas containing the carbon dioxide from the air pressure fed using the fan. For example, the separation device employs any one or a plurality of separation methods such as adsorption separation, membrane separation, cooling separation, centrifugal separation, gravity separation, or gas-liquid separation.

The separation device using the adsorption separation performs separation by, for example, adsorbing a specific component onto an adsorbent or an adsorption liquid, or the like. Examples of the adsorbent include silica gel, zeolite, activated carbon, and the like. Specifically, by adsorbing the component containing the carbon dioxide onto the adsorbent, this component can be separated from other components. The adsorbent may be in a granular form, a powdery form, or the like. The granular form is, for example, a bead form (spherical form), a pellet form (cylindrical form), or the like. In a case in which the adsorbent in the powdery form is used, the adsorbent may be supported on a surface of a base material. The base material may have, for example, a honeycomb shape.

The separation device using the adsorption separation has a function of separating the carbon dioxide from the adsorbent. The separation device includes, for example, a heating device. The heating device separates the carbon dioxide from the adsorbent by heating the adsorbent. The separation device may be equipped with a decompression device such as a decompression pump. The decompression device separates the carbon dioxide from the adsorbent by placing the adsorbent under a reduced pressure.

The separation device using the membrane separation separates a specific component from other components by using, for example, a permeable membrane through which low-molecular-weight components can pass. Specifically, for example, a component containing hydrogen (H2) can be separated from the component including the carbon dioxide by using a palladium permeable membrane.

The separation device using the cooling separation liquefies, for example, a specific component by cooling to separate the specific component from other components (gas). Specifically, a component containing water (H2O) can be liquefied and separated from a gas containing the carbon dioxide.

The separation device using the centrifugal separation liquefies, for example, a specific component (component containing water) by cooling to separate the specific component from other components (gas containing the carbon dioxide) by using a centrifugal force. The separation device using the gravity separation liquefies, for example, a specific component (component containing water) by cooling to separate the specific component from other components (gas containing the carbon dioxide) by using a gravity force. The separation device using the gas-liquid separation liquefies, for example, a specific component (component containing water) by cooling to separate the specific component from other components (gas containing the carbon dioxide) by using gravity, centrifugal force, surface tension, or the like.

The recycled carbon dioxide concentration device 22 increases a concentration of the carbon dioxide (referred to as recycled carbon dioxide) recovered by the carbon dioxide recovery device 21. As in the carbon dioxide recovery device 21, the recycled carbon dioxide concentration device 22 increases a concentration of the carbon dioxide by employing any one or a plurality of separation methods such as the adsorption separation, the membrane separation, the cooling separation, the centrifugal separation, the gravity separation, and the gas-liquid separation. It should be noted that, in a case in which the concentration of the recycled carbon dioxide recovered by the carbon dioxide recovery device 21 is high, the recycled carbon dioxide concentration device 22 may be omitted.

The recycled carbon dioxide storage equipment 23 is equipment that temporarily stores the recycled carbon dioxide. The recycled carbon dioxide storage equipment 23 includes, for example, a storage tank. For example, the recycled carbon dioxide stored in the recycled carbon dioxide storage equipment 23 is stored in a liquefied state by being cooled. The volume of the recycled carbon dioxide can be reduced by liquefying the recycled carbon dioxide. The recycled carbon dioxide can be carried in and out of the recycled carbon dioxide storage equipment 23 by using piping or the like. In addition, the recycled carbon dioxide may be carried in and out of the recycled carbon dioxide storage equipment 23 by using a transport container.

The recycled carbon dioxide filling device 24 fills an object outside the carbon dioxide recovery system 2 with the recycled carbon dioxide stored in the recycled carbon dioxide storage equipment 23. Here, the object outside the carbon dioxide recovery system 2 is, for example, a heat pump device 31 included in the carbon storage system 3, which will be described below. That is, the heat pump device 31 can be filled with the recycled carbon dioxide directly from the recycled carbon dioxide filling device 24.

In addition, the object outside the carbon dioxide recovery system 2 may be a container such as a cylinder 5 or the like that temporarily stores the recycled carbon dioxide before the recycled carbon dioxide is supplied to the heat pump device 31. That is, the recycled carbon dioxide can be indirectly supplied to the heat pump device 31 from the recycled carbon dioxide filling device 24 through the cylinder 5 or the like. Further, the object outside the carbon dioxide recovery system 2 may be another device.

The carbon storage system 3 includes the heat pump device 31. As shown in FIG. 1, the carbon storage system 3 includes a plurality of heat pump devices 31. It should be noted that the heat pump device 31 included in the carbon storage system 3 may be a single unit. The carbon storage system 3 stores at least carbon contained in the recycled carbon dioxide recovered by the carbon dioxide recovery system 2. In the present embodiment, the carbon storage system 3 stores the recycled carbon dioxide itself by using the recycled carbon dioxide as a heat medium for the heat pump device 31. That is, the heat pump system 1 includes the carbon dioxide recovery system 2 that recovers the carbon dioxide from the air by using the energy, and the heat pump device 31 that stores at least the carbon contained in the carbon dioxide recovered by the carbon dioxide recovery system 2.

Each of the heat pump devices 31 is a device that performs heat transport by using the carbon dioxide heat medium. Each of the heat pump devices 31 is, for example, an air conditioner, a refrigerator, or a water heater. These heat pump devices 31 are merely examples. The heat pump device 31 may be a heat pump device different from the air conditioner, the refrigerator, and the water heater.

The recycled carbon dioxide recovered by the carbon dioxide recovery system 2 is supplied to each of the heat pump devices 31 as a heat medium X. The recycled carbon dioxide circulates as the heat medium X inside each of the heat pump devices 31. That is, each of the heat pump devices 31 stores the heat medium X consisting of the recycled carbon dioxide. The heat medium X consists of the recycled carbon dioxide and is a carbon-containing heat medium that contains the carbon.

The purity of the heat medium X (carbon dioxide heat medium) used in each of the heat pump devices 31 is preferably 99.5% or higher, but is not limited to this, and may be 99.4% or lower. In a case in which the purity of the heat medium X is 99.4%, for example, a degree of concentration in the recycled carbon dioxide concentration device 22 can be reduced. Therefore, an amount of energy required for concentrating the recycled carbon dioxide in the recycled carbon dioxide concentration device 22 can be reduced.

The re-recovery system 4 recovers the heat medium X stored in each of the heat pump devices 31. The re-recovery system 4 recovers the heat medium X to recover the carbon that is recovered by the carbon dioxide recovery system 2 and stored in the heat pump device 31. The re-recovery system 4 can recover the heat medium X, for example, at a timing of disposal of each of the heat pump devices 31. In addition, the re-recovery system 4 may recover the heat medium X at a timing when the heat medium X needs to be exchanged in each of the heat pump devices 31.

The heat medium X recovered by the re-recovery system 4 consists of the recycled carbon dioxide. Therefore, as shown in FIG. 1, the re-recovery system 4 can return the recovered heat medium X to the carbon dioxide recovery system 2. The heat medium X returned to the carbon dioxide recovery system 2 is stored in, for example, the recycled carbon dioxide storage equipment 23. The heat medium X returned to the carbon dioxide recovery system 2 may be supplied to the recycled carbon dioxide filling device 24.

In this way, the heat medium X returned to the carbon dioxide recovery system 2 is supplied to a different heat pump device 31 through the recycled carbon dioxide filling device 24. That is, the different heat pump device 31 to which the heat medium X recovered by the re-recovery system 4 is supplied stores the carbon recovered by the re-recovery system 4.

The heat medium X recovered by the re-recovery system 4 needs not be returned to the carbon dioxide recovery system 2. The heat medium X recovered by the re-recovery system 4 can also be used in equipment or the like different from the heat pump system 1 according to the present Embodiment 1. In addition, in a case in which the recovery of the heat medium X in each of the heat pump devices 31 is not required, the re-recovery system 4 can be omitted.

In the heat pump system 1 according to the present Embodiment 1, the carbon dioxide is recovered from the air by the carbon dioxide recovery system 2 by using the energy. Specifically, the carbon dioxide is recovered from the air by using the renewable energy or the like by way of the carbon dioxide recovery device 21. The carbon dioxide (recycled carbon dioxide) recovered by the carbon dioxide recovery device 21 is concentrated by the recycled carbon dioxide concentration device 22. In the recycled carbon dioxide concentration device 22, the concentration of the recycled carbon dioxide is increased.

The recycled carbon dioxide concentrated by the recycled carbon dioxide concentration device 22 is temporarily stored in the recycled carbon dioxide storage equipment 23. The recycled carbon dioxide stored in the recycled carbon dioxide storage equipment 23 is supplied directly or indirectly to the carbon storage system 3, as the heat medium X, by the recycled carbon dioxide filling device 24.

The heat medium X supplied to the carbon storage system 3 is supplied to the heat pump device 31. The heat medium X supplied to each of the heat pump devices 31 is used for heat transport in each of the heat pump devices 31. In addition, the heat medium X supplied to the heat pump device 31 is recovered by the re-recovery system 4 at the timing of disposal or the like of the heat pump device 31. The heat medium X recovered by the re-recovery system 4 is returned to the carbon dioxide recovery system 2. The heat medium X returned to the carbon dioxide recovery system 2 is stored in the recycled carbon dioxide storage equipment 23 or the like, and then is supplied to the different heat pump device 31.

The heat pump system 1 according to the present Embodiment 1 includes the carbon dioxide recovery system 2 and the heat pump device 31, as described above. The carbon dioxide recovery system 2 recovers the carbon dioxide from the air by using the energy. The heat pump device 31 stores at least the carbon contained in the carbon dioxide recovered by the carbon dioxide recovery system 2.

With the heat pump system 1, the recovered carbon dioxide can be stored in the heat pump device 31 for a long period of time. As described above, with the heat pump system 1, the carbon contained in the recovered carbon dioxide can be fixed in the heat pump device 31. Therefore, use of the recovered carbon dioxide can be expanded, and the carbon dioxide released into the air can be reduced.

In addition, in the heat pump system 1 according to the present Embodiment 1, the heat pump device 31 stores the carbon-containing heat medium (heat medium X) that contains the carbon. With the heat pump device 31, the carbon contained in the carbon dioxide recovered by the carbon dioxide recovery system 2 can be effectively utilized as the carbon-containing heat medium. Therefore, it is not required to newly generate the heat medium used in the heat pump device 31. Therefore, global warming can be suppressed.

In addition, in the heat pump system 1 according to the present Embodiment 1, the carbon-containing heat medium is the carbon dioxide heat medium. With the heat pump system 1, the recovered carbon dioxide can be used as the heat medium in the original form of the carbon dioxide. Therefore, the heat pump system 1 according to the present Embodiment 1 does not need to perform decomposition treatment or the like on the carbon dioxide and can have a simpler configuration.

In addition, in the heat pump system 1 according to the present Embodiment 1, the purity of the carbon dioxide heat medium is preferably 99.5% or higher, but is not limited to this, and may be 99.4% or lower. In a case in which the purity of the heat medium X is 99.4%, the amount of energy required for concentrating the recycled carbon dioxide can be reduced.

In addition, the heat pump system 1 according to the present Embodiment 1 includes the re-recovery system 4 that recovers carbon from the heat pump device 31. With the heat pump system 1, the carbon stored in the heat pump device 31 can be reused.

In addition, the heat pump system 1 according to the present Embodiment 1 includes another heat pump device 31 different from the heat pump device 31 from which the carbon is recovered by the re-recovery system 4. The other heat pump device 31 stores the carbon recovered by the re-recovery system 4. With the heat pump system 1, the carbon recovered by the re-recovery system 4 is not discharged outside the heat pump system 1. Therefore, the heat pump system 1 can achieve negative emissions.

In addition, in the present Embodiment 1, the heat pump device 31 that recovers the carbon dioxide from the air by using the energy and stores at least the carbon contained in the recovered carbon dioxide is manufactured. With a method for manufacturing the heat pump device 31, the recovered carbon dioxide can be stored in the heat pump device 31 for a long period of time. As described above, with the method for manufacturing the heat pump device 31, the carbon contained in the recovered carbon dioxide can be fixed in the heat pump device 31. Therefore, use of the recovered carbon dioxide can be expanded, and the carbon dioxide released into the air can be reduced.

### Embodiment 2

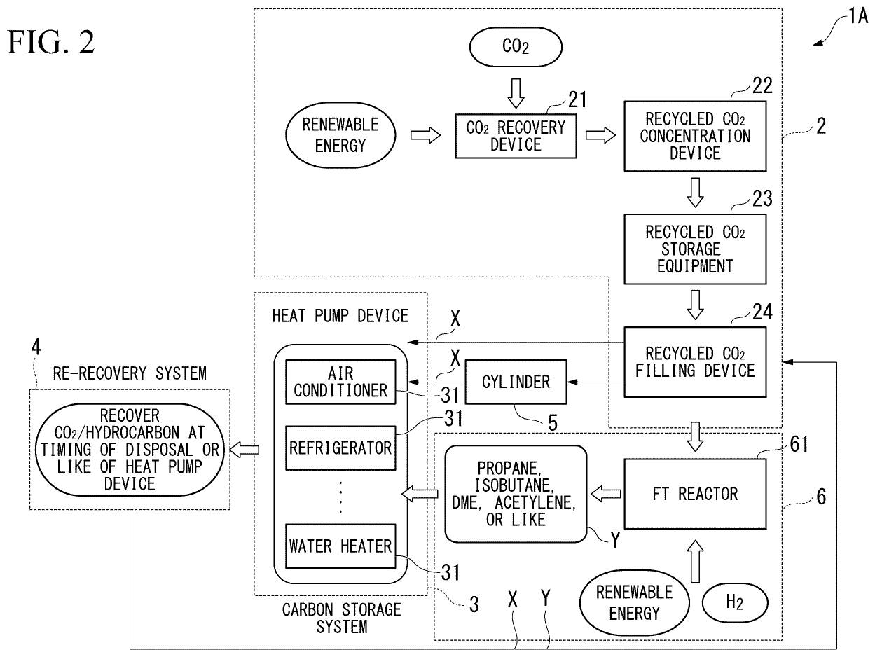

Next, Embodiment 2 of the present disclosure will be described with reference to FIG. 2. It should be noted that, in the description of the present Embodiment 2, the description of the same parts as those in the description of Embodiment 1 will be omitted or simplified.

FIG. 2 is a block diagram showing a heat pump system 1A according to Embodiment 2. As shown in FIG. 2, the heat pump system 1A according to Embodiment 2 includes a hydrocarbon generation system 6. The hydrocarbon generation system 6 generates hydrocarbon Y by using the carbon dioxide (recycled carbon dioxide) recovered by carbon dioxide recovery system 2. In the present Embodiment 2, the hydrocarbon generation system 6 includes an FT reactor 61.

In the FT reactor 61, the hydrocarbon Y is generated from the carbon dioxide by using a Fischer-Tropsch reaction. In the FT reactor 61, the hydrocarbon Y is synthesized from a mixed gas in which the recycled carbon dioxide and externally supplied hydrogen are mixed, by using a catalyst. It should be noted that renewable energy can be used as the energy required in the FT reactor 61.

The hydrocarbon Y generated in the hydrocarbon generation system 6 is, for example, propane, isobutane, dimethyl ether (DME), or acetylene. However, the type of the hydrocarbon Y is not particularly limited.

The hydrocarbon Y generated in the FT reactor 61 is, for example, a liquid. Therefore, the hydrocarbon Y generated in the FT reactor 61 can be used as the heat medium of the heat pump device 31. Therefore, in the present Embodiment 2, the hydrocarbon Y generated in the hydrocarbon generation system 6 is supplied to the heat pump device 31 as the heat medium (hydrocarbon heat medium). That is, in the present Embodiment 2, the carbon-containing heat medium is the hydrocarbon heat medium.

In the present Embodiment 2, the carbon dioxide heat medium (heat medium X) is stored in part of the plurality of heat pump devices 31 included in the carbon storage system 3. The hydrocarbon Y is stored as the heat medium in part of the plurality of heat pump devices 31 included in the carbon storage system 3.

The hydrocarbon Y is generated by using the carbon dioxide recovered by the carbon dioxide recovery system 2 and has the carbon contained in the carbon dioxide recovered by the carbon dioxide recovery system 2. Therefore, the heat pump device 31 that stores the hydrocarbon Y stores at least the carbon contained in the carbon dioxide recovered by the carbon dioxide recovery system 2.

In addition, in the present embodiment 2, the re-recovery system 4 can return the hydrocarbon Y recovered from the heat pump device 31 to the carbon dioxide recovery system 2, in addition to the heat medium X that is the carbon dioxide heat medium. For example, the hydrocarbon Y returned to the carbon dioxide recovery system 2 is stored in a different container from the heat medium X that is the carbon dioxide heat medium and is supplied to a different heat pump device 31 as necessary. It should be noted that the storage location of the hydrocarbon Y recovered by the re-recovery system 4 is not limited to the carbon dioxide recovery system 2 and may be storage equipment installed outside the carbon dioxide recovery system 2.

In the heat pump system 1A according to the present Embodiment 2 as described above, the heat pump device 31 stores at least the carbon contained in the carbon dioxide recovered by the carbon dioxide recovery system 2. With the heat pump system 1A, the recovered carbon dioxide can be stored in the heat pump device 31 for a long period of time. As described above, with the heat pump system 1A, the carbon contained in the recovered carbon dioxide can be fixed in the heat pump device 31. Therefore, use of the recovered carbon dioxide can be expanded, and the carbon dioxide released into the air can be reduced.

In addition, the heat pump system 1A according to the present Embodiment 2 includes the hydrocarbon generation system 6. The hydrocarbon generation system 6 generates the hydrocarbon Y by using the carbon dioxide recovered by the carbon dioxide recovery system 2. In addition, in the heat pump system 1 according to the present Embodiment 2, the carbon-containing heat medium is the hydrocarbon heat medium.

With the heat pump system 1 according to the present Embodiment 2, the carbon storage system 3 can include the heat pump device 31 that uses the hydrocarbon Y as the heat medium. Therefore, use of the carbon dioxide recovered by the carbon dioxide recovery system 2 can be further expanded.

It should be noted that the hydrocarbon generation system 6 may include a co-electrolysis device. The co-electrolysis device obtains a mixed gas containing carbon monoxide (CO) and hydrogen from the carbon dioxide and water through co-electrolysis.

For example, the co-electrolysis device includes a solid oxide electrolysis cell including a cathode electrode and an anode electrode. For example, in the solid oxide electrolysis cell, solid oxide with oxygen ion conductivity is used. As the electrolyte, zirconia-based oxides or the like is used. The co-electrolysis device is an example of an electrolysis device. The co-electrolysis device supplies the supplied water (or water and carbon dioxide) to the cathode electrode of the solid oxide electrolysis cell. It is desirable that the water used in the co-electrolysis in the solid oxide electrolysis cell is steam. In addition, in the co-electrolysis device, a recovery gas containing the carbon dioxide is supplied to the cathode electrode of the solid oxide electrolysis cell.

The co-electrolysis device may include a heating device that heats the solid oxide electrolysis cell. The heating device can adjust a temperature within the solid oxide electrolysis cell to a temperature suitable for the co-electrolysis reaction. The ratio of the carbon dioxide and the water that are supplied to the solid oxide electrolysis cell can be determined depending on a ratio of the components (carbon monoxide and hydrogen) of the target mixed gas.

It should be noted that the device for obtaining the carbon monoxide and the hydrogen is not limited to the co-electrolysis device. For example, an electrolysis device in which a step of electrolyzing the carbon dioxide to obtain the carbon monoxide and a step of electrolyzing the water to obtain the hydrogen are independently performed can also be used.

In a case in which the co-electrolysis device is provided, the FT reactor 61 generates the hydrocarbon Y from the carbon monoxide. The FT reactor 61 synthesizes the hydrocarbon Y from a mixed gas in which the hydrogen and the carbon monoxide generated by the co-electrolysis device are mixed, by using a catalyst.

### Embodiment 3

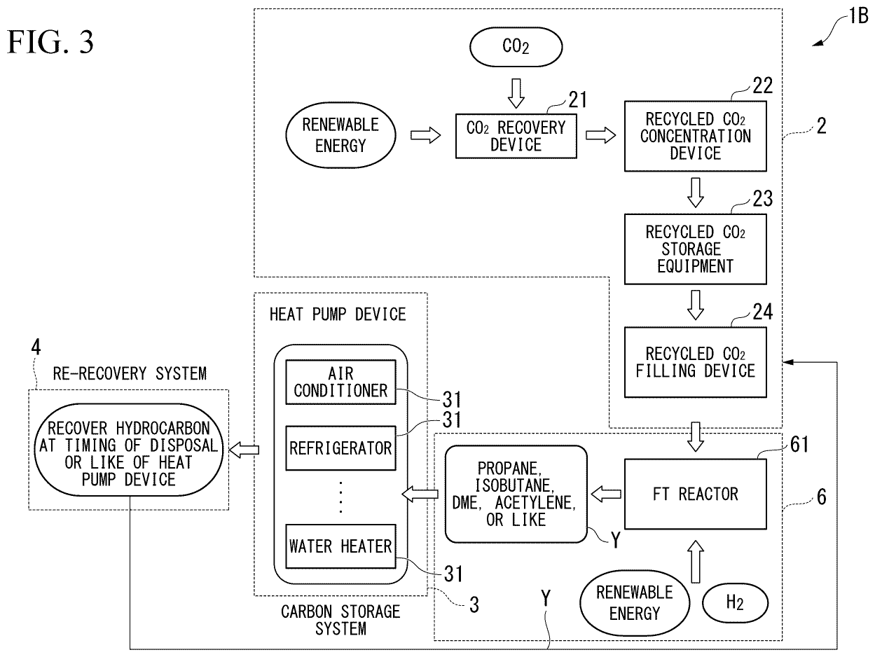

Next, Embodiment 3 of the present disclosure will be described with reference to FIG. 3. It should be noted that, in the description of the present Embodiment 3, the description of the same parts as those in the description of Embodiment 1 or Embodiment 2 will be omitted or simplified.

FIG. 3 is a block diagram showing a heat pump system 1B according to Embodiment 3. As shown in FIG. 3, the heat pump system 1B according to Embodiment 3 does not have a path for filling the heat pump device 31 with the carbon dioxide from the recycled carbon dioxide filling device 24 as the heat medium X.

On the other hand, as shown in FIG. 3, the heat pump system 1B according to Embodiment 3 includes a hydrocarbon generation system 6. The hydrocarbon generation system 6 generates hydrocarbon Y by using the carbon dioxide (recycled carbon dioxide) recovered by carbon dioxide recovery system 2. That is, the heat pump system 1B according to the present Embodiment 3 supplies all the carbon dioxide recovered by the carbon dioxide recovery system 2 to the hydrocarbon generation system 6. It should be noted that part of the carbon dioxide recovered by the carbon dioxide recovery system 2 may be supplied to the hydrocarbon generation system 6. The remaining carbon dioxide is not limited to being used as the hydrocarbon refrigerant in the heat pump device 31 as in the second embodiment and can also be supplied to the outside of the heat pump system 1B. For example, a production amount of the hydrocarbon generated by the hydrocarbon generation system 6 may be adjusted, and the excess carbon dioxide may be provided to the outside.

In the present Embodiment 3, the re-recovery system 4 returns the hydrocarbon Y recovered from the heat pump device 31 to the carbon dioxide recovery system 2. For example, the hydrocarbon Y returned to the carbon dioxide recovery system 2 is stored in a different container from the heat medium X that is the carbon dioxide heat medium and is supplied to a different heat pump device 31 as necessary. It should be noted that the storage location of the hydrocarbon Y recovered by the re-recovery system 4 is not limited to the carbon dioxide recovery system 2 and may be storage equipment installed outside the carbon dioxide recovery system 2.

In the heat pump system 1B according to the present Embodiment 2 as described above, the heat pump device 31 stores at least the carbon contained in the carbon dioxide recovered by the carbon dioxide recovery system 2. With the heat pump system 1B, the recovered carbon dioxide can be stored in the heat pump device 31 for a long period of time. As described above, with the heat pump system 1B, the carbon contained in the recovered carbon dioxide can be fixed in the heat pump device 31. Therefore, use of the recovered carbon dioxide can be expanded, and the carbon dioxide released into the air can be reduced.

### Embodiment 4

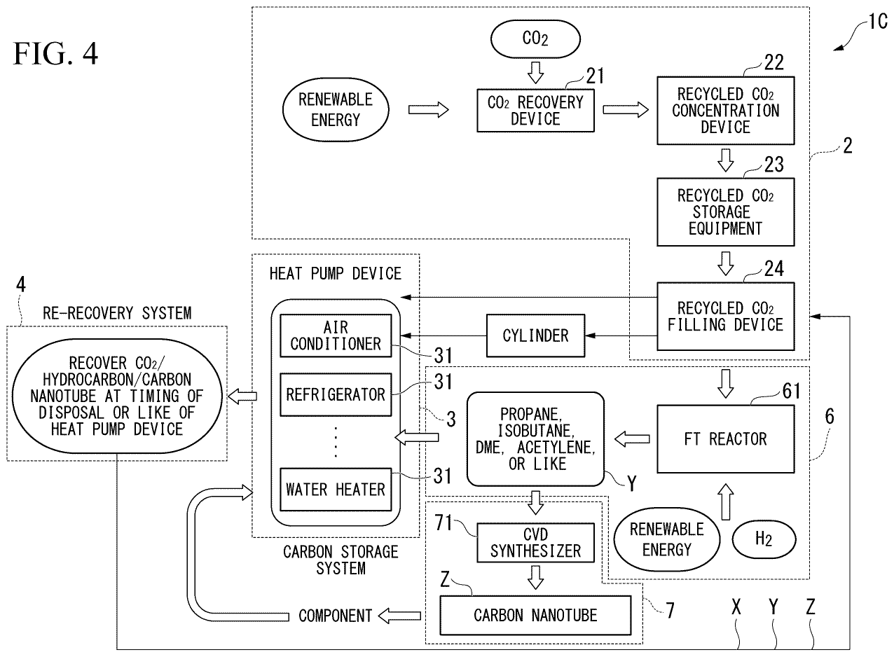

Next, Embodiment 4 of the present disclosure will be described with reference to FIG. 4. It should be noted that, in the description of the present Embodiment 4, the description of the same parts as those in the description of Embodiment 1 or Embodiment 2 will be omitted or simplified.

FIG. 4 is a block diagram showing a heat pump system 1C according to Embodiment 4. As shown in FIG. 4, the heat pump system 1C according to Embodiment 4 includes a hydrocarbon generation system 6 and a carbon nanotube generation system 7. The carbon nanotube generation system 7 generates carbon nanotube Z by using the hydrocarbon Y generated by the hydrocarbon generation system 6 as a raw material. In the present Embodiment 4, the carbon nanotube generation system 7 includes a CVD synthesizer 71.

The CVD synthesizer 71 generates the carbon nanotube Z by using the chemical vapor deposition (CVD) method. Examples of the CVD method include a catalytic chemical vapor deposition (CCVD) method. This catalytic chemical vapor deposition method involves thermally decomposing the hydrocarbon, which serves as a carbon source, in a reaction furnace at a temperature of about 700° C. to 1000° C. in the presence of a catalytic metal, and then reacting the thermally decomposed carbon source with the catalytic metal. Examples of the catalytic chemical vapor deposition method include a method using methane as the carbon source (plasma-enhanced CCVD method). Examples of the catalytic chemical vapor deposition method also include a method (thermal CCVD method) using acetylene or ethylene as the carbon source. As the catalytic metal used in the catalytic chemical vapor deposition method, iron, cobalt, and nickel are mainly used.

In addition, as the CVD method, a water-assisted-CCVD method (super-growth method) may be used. The super-growth method is an innovative carbon nanotube synthesis technology with a production efficiency approximately 1,000 times greater than that of a general CVD method. The super-growth method is a type of the thermal CCVD method and is a generation method characterized by the addition of extremely low-concentration water along with the carbon source during a carbon nanotube generation step.

The carbon nanotube Z generated by the carbon nanotube generation system 7 is used, for example, as a raw material of a composite material. By using the composite material containing the carbon nanotube Z, a component (for example, a heat exchanger) of the heat pump device 31 can be manufactured. The heat pump device 31 according to the present Embodiment 4 includes a component formed of the composite material. That is, the heat pump device 31 according to the present Embodiment 4 stores the carbon nanotube Z generated by the carbon nanotube generation system 7.

The carbon nanotube Z generated by the carbon nanotube generation system 7 is formed of the carbon contained in the carbon dioxide (recycled carbon dioxide) recovered by the carbon dioxide recovery system 2. Therefore, the heat pump device 31 that stores the carbon nanotube Z stores at least the carbon contained in the carbon dioxide recovered by the carbon dioxide recovery system 2.

In addition, in the present embodiment 4, the re-recovery system 4 can return the carbon nanotube Z recovered from the heat pump device 31 to the carbon dioxide recovery system 2, in addition to the heat medium X, which is the carbon dioxide heat medium, and the hydrocarbon Y. The re-recovery system 4 decomposes the recovered composite material to separate the carbon nanotube Z and returns the separated carbon nanotube Z to the carbon dioxide recovery system 2. For example, the carbon nanotube Z returned to the carbon dioxide recovery system 2 is stored in a different container from the heat medium X that is the carbon dioxide heat medium, is used as a material of the composite material as necessary and is incorporated into the different heat pump device 31. It should be noted that the storage location of the carbon nanotube Z recovered by the re-recovery system 4 is not limited to the carbon dioxide recovery system 2 and may be storage equipment installed outside the carbon dioxide recovery system 2.

In the heat pump system 1C according to the present Embodiment 4 as described above, the heat pump device 31 stores at least the carbon contained in the carbon dioxide recovered by the carbon dioxide recovery system 2. With the heat pump system 1C, the recovered carbon dioxide can be stored in the heat pump device 31 for a long period of time. As described above, with the heat pump system 1C, the carbon contained in the recovered carbon dioxide can be fixed in the heat pump device 31. Therefore, use of the recovered carbon dioxide can be expanded, and the carbon dioxide released into the air can be reduced.

In addition, the heat pump system 1C according to the present Embodiment 4 includes the carbon nanotube generation system 7. The carbon nanotube generation system 7 generates the carbon nanotube Z by using the hydrocarbon as a raw material.

With the heat pump system 1 according to the present Embodiment 4, the carbon nanotube Z is generated in the carbon storage system 3 by using the carbon dioxide recovered by the carbon dioxide recovery system 2. Therefore, use of the carbon dioxide recovered by the carbon dioxide recovery system 2 can be further expanded.

In the heat pump system 1 according to the present Embodiment 4, the heat pump device 31 includes a component including the carbon nanotube. Therefore, the recovered carbon can be easily fixed in the heat pump device 31 for a long period of time.

### Embodiment 5

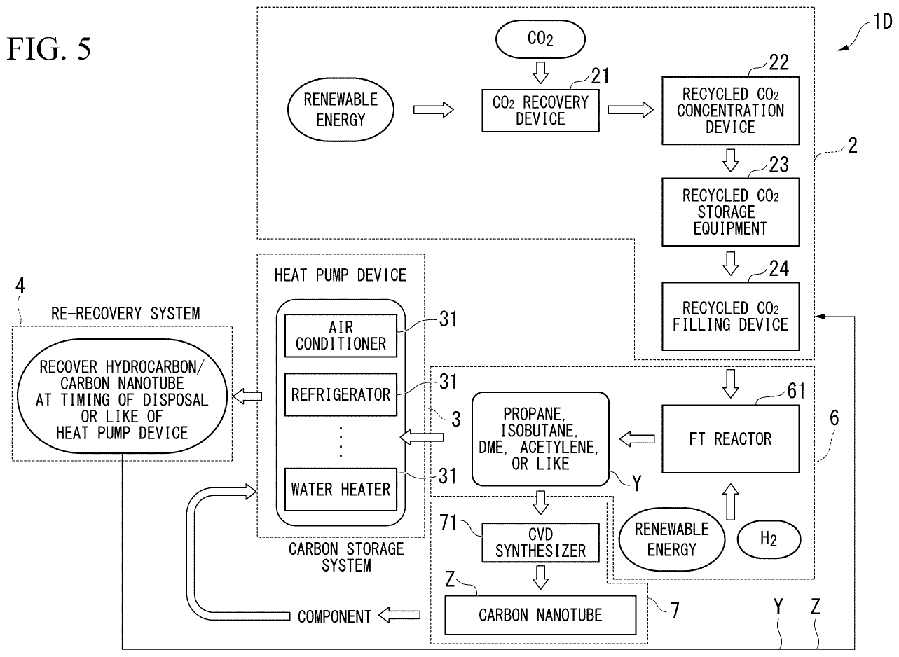

Next, Embodiment 5 of the present disclosure will be described with reference to FIG. 5. It should be noted that, in the description of the present Embodiment 5, the description of the same parts as those in Embodiment 1 or Embodiment 4 will be omitted or simplified.

FIG. 5 is a block diagram showing a heat pump system 1D according to Embodiment 5. As shown in FIG. 5, the heat pump system 1D according to Embodiment 5 does not have a path for filling the heat pump device 31 with the carbon dioxide from the recycled carbon dioxide filling device 24 as the heat medium X.

On the other hand, as shown in FIG. 5, the heat pump system 1D according to Embodiment 5 includes a hydrocarbon generation system 6 and a carbon nanotube generation system 7. The hydrocarbon generation system 6 generates hydrocarbon Y by using the carbon dioxide (recycled carbon dioxide) recovered by a carbon dioxide recovery system 2. The carbon nanotube generation system 7 generates a carbon nanotube Z by using the hydrocarbon Y as a raw material. That is, the heat pump system 1D according to the present Embodiment 5 supplies all the carbon dioxide recovered by the carbon dioxide recovery system 2 to the hydrocarbon generation system 6. It should be noted that part of the carbon dioxide recovered by the carbon dioxide recovery system 2 may be supplied to the hydrocarbon generation system 6. The remaining carbon dioxide is not limited to being used as the hydrocarbon refrigerant in the heat pump device 31 as in the second embodiment and can also be supplied to the outside of the heat pump system 1D. For example, a production amount of the hydrocarbon generated by the hydrocarbon generation system 6 may be adjusted, and the excess carbon dioxide may be provided to the outside.

In the present Embodiment 5, the re-recovery system 4 returns the hydrocarbon Y recovered from the heat pump device 31 to the carbon dioxide recovery system 2. For example, the hydrocarbon Y returned to the carbon dioxide recovery system 2 is stored in a different container from the heat medium X that is the carbon dioxide heat medium and is supplied to a different heat pump device 31 as necessary. It should be noted that the storage location of the hydrocarbon Y recovered by the re-recovery system 4 is not limited to the carbon dioxide recovery system 2 and may be storage equipment installed outside the carbon dioxide recovery system 2.

The re-recovery system 4 returns the carbon nanotube Z recovered from the heat pump device 31 to the carbon dioxide recovery system 2. For example, the carbon nanotube Z returned to the carbon dioxide recovery system 2 is stored in a different container from the heat medium X that is the carbon dioxide heat medium, is used as a material of the composite material as necessary and is incorporated into the different heat pump device 31. It should be noted that the storage location of the carbon nanotube Z recovered by the re-recovery system 4 is not limited to the carbon dioxide recovery system 2 and may be storage equipment installed outside the carbon dioxide recovery system 2.

In the heat pump system 1D according to the present Embodiment 5 as described above, the heat pump device 31 stores at least the carbon contained in the carbon dioxide recovered by the carbon dioxide recovery system 2. With the heat pump system 1D, the recovered carbon dioxide can be stored in the heat pump device 31 for a long period of time. As described above, with the heat pump system 1D, the carbon contained in the recovered carbon dioxide can be fixed in the heat pump device 31. Therefore, use of the recovered carbon dioxide can be expanded, and the carbon dioxide released into the air can be reduced.

### Embodiment 6

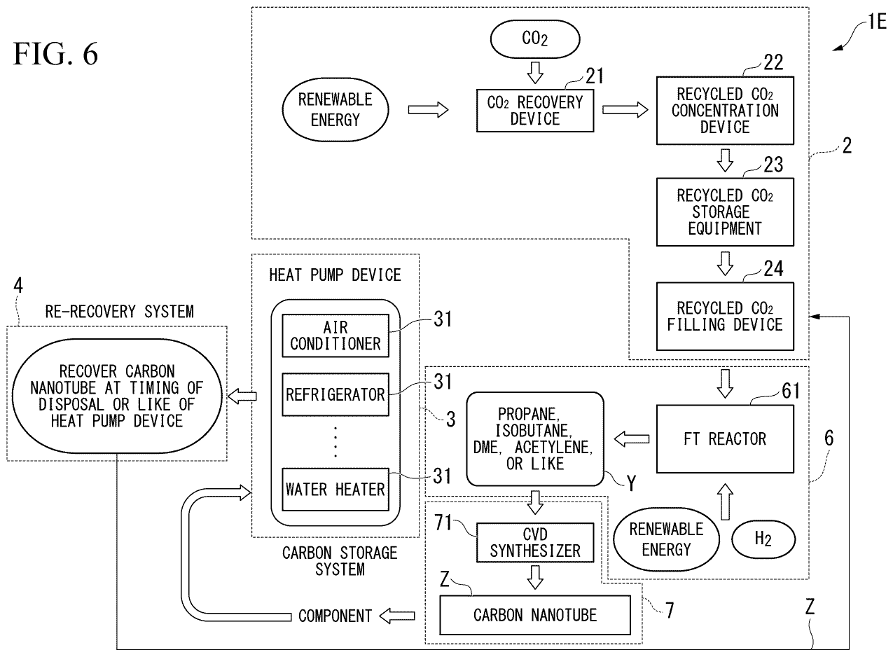

Next, Embodiment 5 of the present disclosure will be described with reference to FIG. 6. It should be noted that, in the description of the present Embodiment 6, the description of the same parts as those in the description of Embodiment 1, Embodiment 4,or Embodiment 5 will be omitted or simplified.

FIG. 6 is a block diagram showing a heat pump system 1E according to Embodiment 6. As shown in FIG. 6, the heat pump system 1E according to Embodiment 6 does not have a path for filling the heat pump device 31 with the carbon dioxide from the recycled carbon dioxide filling device 24 as the heat medium X. Further, the hydrocarbon Y generated by the hydrocarbon generation system 6 is not supplied to the heat pump device 31 as a heat medium.

On the other hand, as shown in FIG. 6, the heat pump system 1E according to Embodiment 6 includes a hydrocarbon generation system 6 and a carbon nanotube generation system 7. The hydrocarbon generation system 6 generates hydrocarbon Y by using the carbon dioxide (recycled carbon dioxide) recovered by carbon dioxide recovery system 2. The carbon nanotube generation system 7 generates a carbon nanotube Z by using the hydrocarbon Y as a raw material. That is, in the heat pump system 1E according to the present Embodiment 6, all the carbon contained in the carbon dioxide recovered by the carbon dioxide recovery system 2 is used for the carbon nanotube Z. It should be noted that part of the carbon contained in the carbon dioxide recovered by the carbon dioxide recovery system 2 can be provided to the outside of the heat pump system 1E. That is, part of the carbon contained in the carbon dioxide recovered by the carbon dioxide recovery system 2 may be used for the carbon nanotube Z.

The re-recovery system 4 returns the carbon nanotube Z recovered from the heat pump device 31 to the carbon dioxide recovery system 2. For example, the carbon nanotube Z returned to the carbon dioxide recovery system 2 is stored in a different container from the heat medium X that is the carbon dioxide heat medium, is used as a material of the composite material as necessary and is incorporated into the different heat pump device 31. It should be noted that the storage location of the carbon nanotube Z recovered by the re-recovery system 4 is not limited to the carbon dioxide recovery system 2 and may be storage equipment installed outside the carbon dioxide recovery system 2.

In the heat pump system 1E according to the present Embodiment 6 as described above, the heat pump device 31 stores at least the carbon contained in the carbon dioxide recovered by the carbon dioxide recovery system 2. With the heat pump system 1E, the recovered carbon dioxide can be stored in the heat pump device 31 for a long period of time. As described above, with the heat pump system 1E, the carbon contained in the recovered carbon dioxide can be fixed in the heat pump device 31. Therefore, use of the recovered carbon dioxide can be expanded, and the carbon dioxide released into the air can be reduced.

It should be noted that, in the present Embodiment 6, a path for filling the heat pump device 31 with carbon dioxide as the heat medium X from the recycled carbon dioxide filling device 24 may be provided.

### Embodiment 7

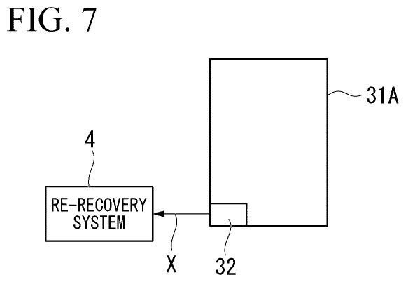

Next, Embodiment 7 of the present disclosure will be described with reference to FIG. 7. It should be noted that, in the description of the present Embodiment 7, the description of the same parts as those in the description of Embodiment 1 will be omitted or simplified.

FIG. 7 is a schematic diagram showing a schematic configuration of a heat pump device 31A included in a heat pump system according to the present Embodiment 7. It should be noted that FIG. 7 shows one of a plurality of heat pump devices 31A included in the heat pump system according to the present Embodiment 7.

As shown in FIG. 7, the heat pump device 31 A included in the heat pump system according to the present Embodiment 7 includes a discharge port 32. The heat pump device 31A is provided with an internal circulation path through which the heat medium X circulates. The discharge port 32 is connected to the circulation path and serves as an outlet for discharging the heat medium X from the circulation path. The discharge port 32 is included in, for example, part of a housing of the heat pump device 31A in an openable and closable manner.

As shown in FIG. 7, the discharge port 32 is connected to the re-recovery system 4. The re-recovery system 4 recovers the heat medium X inside the heat pump device 31A through the discharge port 32. That is, the heat pump device 31A includes the discharge port 32 through which the stored carbon (heat medium X) can be discharged.

With the heat pump system according to the present Embodiment 7, the heat medium X stored inside the heat pump device 31A can be easily extracted to the outside of the heat pump device 31A through the discharge port 32.

### Embodiment 8

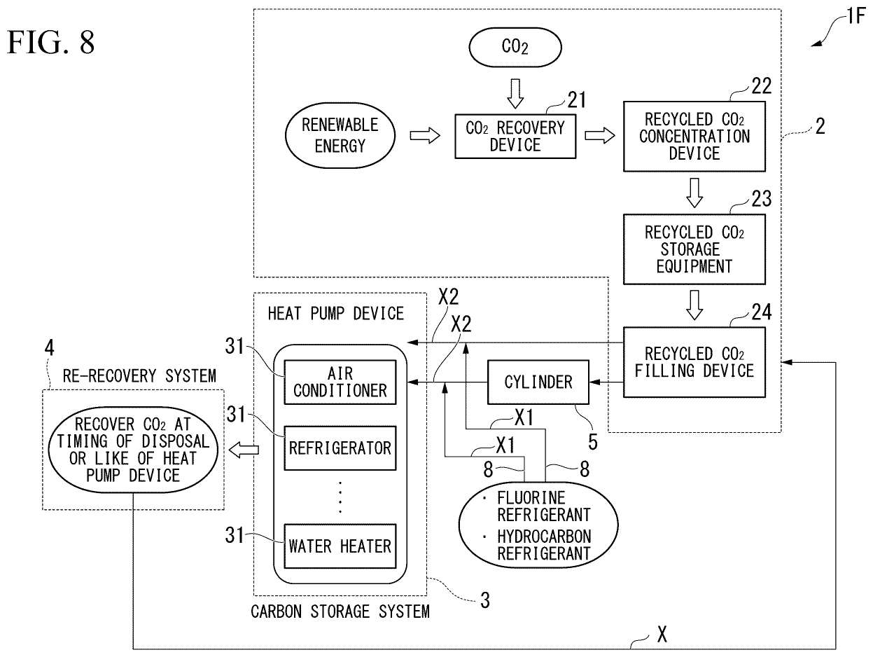

Next, Embodiment 8 of the present disclosure will be described with reference to FIG. 8. It should be noted that, in the description of the present Embodiment 8, the description of the same parts as those in the description of Embodiment 1 will be omitted or simplified.

FIG. 8 is a block diagram showing a heat pump system 1F according to Embodiment 8. As shown in FIG. 8, the heat pump system 1F according to Embodiment 8 is provided with a mixing flow path 8 for mixing a different heat medium X1 with the heat medium X supplied from the carbon dioxide recovery system 2 to the heat pump device 31. As the different heat medium X1, a fluorine heat medium, a hydrocarbon heat medium, or the like can be used.

In the present Embodiment 8, the heat pump device 31 stores a mixed heat medium X2 in which the heat medium X and the different heat medium X1 are mixed. As described above, the heat pump device 31 can also store the mixed heat medium X2. By using the mixed heat medium X2, an effect that cannot be achieved by using the heat medium X or the different heat medium X1 alone can be obtained.

For example, the mixed heat medium X2 in which the heat medium X, which is the carbon dioxide heat medium, is mixed has a higher gas density than the different heat medium X1, such as a fluorine heat medium. Therefore, a gas flow velocity of the mixed heat medium X2 inside the heat pump device 31 is smaller than a gas flow velocity in a case in which only the different heat medium X1 is used. Therefore, the heat pump system 1F according to the present Embodiment 8 can reduce a pressure loss in the heat pump device 31.

### Embodiment 9

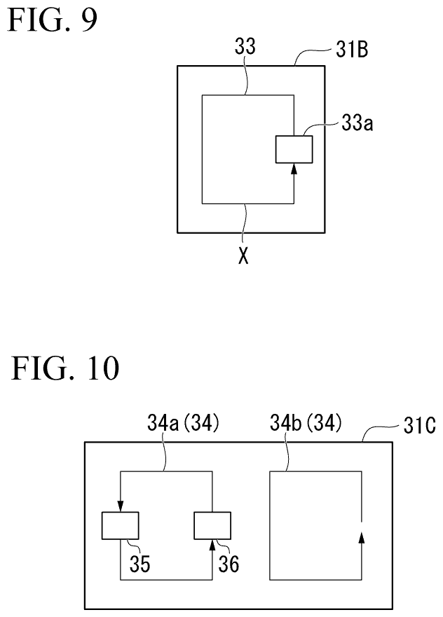

Next, Embodiment 9 of the present disclosure will be described with reference to FIG. 9. It should be noted that, in the description of the present Embodiment 9, the description of the same parts as those in the description of Embodiment 1 will be omitted or simplified.”FIG. 9 is a schematic diagram showing a schematic configuration of a heat pump device 31B included in a heat pump system according to the present Embodiment 9. It should be noted that FIG. 9 shows one of a plurality of heat pump devices 31B included in the heat pump system according to the present Embodiment 9.

As shown in FIG. 9, the heat pump device 31B included in the heat pump system according to the present Embodiment 9 is provided therein with a circulation path 33 (circulation section) through which the heat medium X circulates. In the circulation path 33, a heat exchanger (not shown), a compressor, a decompressor, a fan, and the like are provided.

As shown in FIG. 9, in the heat pump system according to the present Embodiment 9, the circulation path 33 includes a buffer tank 33 a (liquid reservoir). The buffer tank 33a is disposed at an intermediate part of a flow path of the heat medium X and temporarily stores the heat medium X.

With the heat pump system according to the present Embodiment 9, in a case in which the buffer tank 33a is provided, an amount of the heat medium X stored in the circulation path 33 can be increased compared to a case in which the buffer tank 33a is not provided. Therefore, with the heat pump system according to the present Embodiment 9, it is possible to prevent a shortage of the heat medium X in each of the heat pump devices 31B and to increase a storage amount of the heat medium X in each of the heat pump devices 31B.

### Embodiment 10

Next, Embodiment 10 of the present disclosure will be described with reference to FIG. 10. It should be noted that, in the description of the present Embodiment 10, the description of the same parts as those in the description of Embodiment 1 will be omitted or simplified.

FIG. 10 is a schematic diagram showing a schematic configuration of a heat pump device 31C included in a heat pump system according to the present Embodiment 10. It should be noted that FIG. 10 shows one of a plurality of heat pump devices 31C included in the heat pump system according to the present Embodiment 10.

As shown in FIG. 10, the heat pump device 31C included in the heat pump system according to the present Embodiment 10 includes a heat exchange system 34 that performs heat exchange by using a heat medium. The heat pump device 31C includes a first heat exchange system 34a including an indoor unit 35 and an outdoor unit 36, and a second heat exchange system 34b that is a different heat exchange system 34 from the first heat exchange system 34a.

The first heat exchange system 34a uses the heat medium X, which is the carbon dioxide heat medium, as the heat medium that performs heat transport between the indoor unit 35 and the outdoor unit 36. The heat medium of the second heat exchange system 34b is not particularly limited, but may be the heat medium X, which is the carbon dioxide heat medium.

The heat pump system according to the present embodiment can use the heat medium X, which is the carbon dioxide heat medium, as the heat medium that performs heat transport between the indoor unit 35 and the outdoor unit 36, which require a large capacity. Therefore, a large amount of the heat medium X, which is the carbon dioxide heat medium, can be stored in the heat pump device 31C.

### Embodiment 11

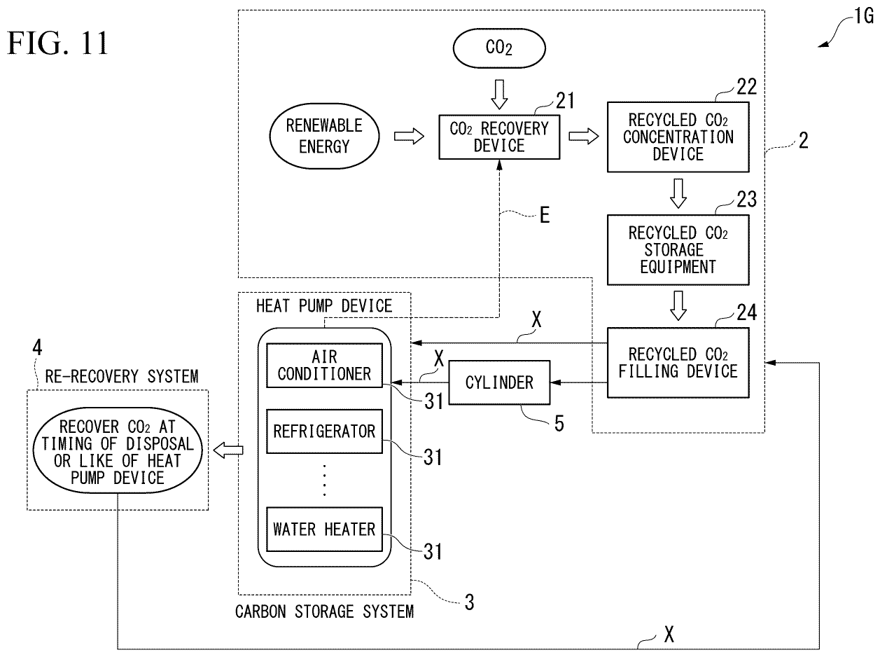

Next, Embodiment 11 of the present disclosure will be described with reference to FIG. 11. It should be noted that, in the description of the present Embodiment 11, the description of the same parts as those in the description of Embodiment 1 will be omitted or simplified.

FIG. 11 is a block diagram showing a heat pump system 1G according to Embodiment 11. As shown in FIG. 11, the heat pump system 1G according to Embodiment 11 supplies energy E obtained by the heat pump device 31 to the carbon dioxide recovery system 2. The energy E supplied to the carbon dioxide recovery system 2 is, for example, cooling energy, heating energy, or blower power.

For example, the carbon dioxide recovery device 21 of the carbon dioxide recovery system 2 recovers carbon dioxide from the air by using the energy E obtained from the heat pump device 31. With the heat pump system 1G of the present embodiment, at least part of the energy E obtained by the heat pump device 31 is consumed by the heat pump system 1G. Therefore, the heat pump system 1G can achieve negative emissions by further increasing an absorption amount of carbon dioxide.

Hitherto, the preferred embodiments of the present disclosure have been described with reference to the accompanying drawings, but it goes saying without that the present disclosure is not limited to the above-described embodiments. Various shapes or combinations of the configuration members shown in the above-described embodiments are merely examples and can be modified in various ways based on design requirements within a range not departing from the gist of the present disclosure. In addition, the above-described embodiments may be combined as appropriate.

In the above-described embodiments, the configuration has been described in which the heat pump device stores the heat medium X, the hydrocarbon Y, or the carbon nanotube Z, thereby fixing the carbon contained in the recovered carbon dioxide in the heat pump device. However, the present disclosure is not limited thereto. In the heat pump system according to the present disclosure, a configuration may be adopted in which the carbon is fixed in the heat pump device by another method.

In the above description, the manufacture of the heat pump device by using the recovered carbon dioxide as the carbon dioxide refrigerant (carbon dioxide heat medium) has been described. In addition, in the above description, the generation of the hydrocarbon from the recovered carbon dioxide and the manufacture of the heat pump device by using the hydrocarbon as the hydrocarbon refrigerant (hydrocarbon heat medium) have been described. In a case in which the heat pump device using the carbon dioxide refrigerant and the heat pump device using the hydrocarbon refrigerant are manufactured, it is advisable to investigate a demand status of each of the heat pump devices. Based on the demand status, production amounts of the carbon dioxide refrigerant and the hydrocarbon refrigerant, which are produced from the recovered carbon dioxide, may be adjusted. By adjusting the production amount, the heat pump device using each refrigerant can be manufactured depending on the demand, thereby efficiently fixing the carbon contained in the recovered carbon dioxide.

In the above-described embodiments, the configuration has been described in which the carbon contained in the recycled carbon dioxide recovered by the carbon dioxide recovery system 2 is fixed in the carbon storage system 3. However, the present disclosure is not limited thereto. For example, it is also possible to fix the carbon contained in the newly manufactured carbon dioxide in the carbon storage system 3 along with the carbon contained in the recycled carbon dioxide. In addition, all the carbon contained in the recycled carbon dioxide recovered by the carbon dioxide recovery system 2 need not be fixed in the carbon storage system 3, and part of the carbon contained in the recycled carbon dioxide recovered by the carbon dioxide recovery system 2 may be fixed in the carbon storage system 3.

### REFERENCE SIGNS LIST

1, 1A, 1B, 1C, 1D, 1E, 1F, 1G: Heat pump system
2: Carbon dioxide recovery system
3: Carbon storage system
4: Re-recovery system
5: Cylinder
6: Hydrocarbon generation system
7: Carbon nanotube generation system
8: Mixing flow path
21: Carbon dioxide recovery device
22: Recycled carbon dioxide concentration device
23: Recycled carbon dioxide storage equipment
24: Recycled carbon dioxide filling device
31, 31A, 31B, 31C: Heat pump device
32: Discharge port
33: Circulation path (circulation section)
33a: Buffer tank
34: Heat exchange system
34a: First heat exchange system
34b: Second heat exchange system
35: Indoor unit
36: Outdoor unit
61: FT reactor
71: CVD synthesizer
X: Heat medium (carbon-containing heat medium)
X1: different heat medium
X2: Mixed heat medium
Y: Hydrocarbon
Z: Carbon nanotube

What is claimed is:

1.-16. (canceled)

17. A heat pump system comprising:
a carbon dioxide recovery system configured to recover carbon dioxide from air by using energy; and
a carbon storage system configured to store, in a heat pump device, a carbon-containing heat medium that contains carbon of the carbon dioxide recovered by the carbon dioxide recovery system,
wherein the carbon dioxide recovery system includes a filling device configured to fill the heat pump device with the carbon-containing heat medium, and
the heat pump device is a plurality of heat pump devices including an air conditioner or a water heater.

18. The heat pump system according to claim 17, further comprising:
a re-recovery system configured to recover the carbon-containing heat medium from the heat pump device,
wherein the filling device fills another heat pump device with the carbon-containing heat medium recovered by the re-recovery system from the heat pump device.

19. The heat pump system according to claim 18,
wherein the heat pump device stores a mixed heat medium in which the carbon-containing heat medium and a different heat medium are mixed.

20. The heat pump system according to claim 18,
wherein the heat pump device includes a plurality of heat exchange systems configured to perform heat exchange by using a heat medium, and
at least one of the heat exchange systems uses the carbon-containing heat medium as the heat medium.

21. The heat pump system according to claim 18,
wherein the heat pump device includes a circulation section through which the carbon-containing heat medium circulates, and
the circulation section includes a liquid reservoir configured to temporarily store the carbon-containing heat medium.

22. The heat pump system according to claim 18,
wherein the carbon-containing heat medium is a carbon dioxide heat medium.

23. The heat pump system according to claim 22,
wherein purity of the carbon dioxide heat medium is 99.4% or lower.

24. The heat pump system according to claim 18, further comprising:
a hydrocarbon generation system configured to generate hydrocarbon by using the carbon dioxide recovered by the carbon dioxide recovery system,
wherein the carbon-containing heat medium is a hydrocarbon heat medium.

25. The heat pump system according to claim 24, further comprising:
a carbon nanotube generation system configured to generate a carbon nanotube by using the hydrocarbon as a raw material.

26. The heat pump system according to claim 25,
wherein the heat pump device includes a component including the carbon nanotube.

27. The heat pump system according to claim 17,
wherein the carbon dioxide recovery system recovers the carbon dioxide from the air using energy supplied from the heat pump device.

28. The heat pump system according to claim 17,
wherein the heat pump device includes a discharge port through which the stored carbon is dischargeable.

29. A method for manufacturing a heat pump device,
wherein a carbon dioxide recovery system configured to recover carbon dioxide from air by using energy, and a carbon storage system configured to store, in a heat pump device, a carbon-containing heat medium that contains carbon of the carbon dioxide recovered by the carbon dioxide recovery system are provided,
the carbon dioxide recovery system includes a filling device configured to fill the heat pump device with the carbon-containing heat medium, and
a plurality of heat pump devices including an air conditioner or a water heater are filled with the carbon-containing heat medium by the filling device.

30. The method for manufacturing a heat pump device according to claim 29,
wherein, in a case in which a carbon dioxide refrigerant and a hydrocarbon refrigerant are produced from the recovered carbon dioxide and the heat pump device using the carbon dioxide refrigerant and the heat pump device using the hydrocarbon refrigerant are manufactured, production amounts of the carbon dioxide refrigerant and the hydrocarbon refrigerant that are produced from the recovered carbon dioxide are adjusted depending on a demand-supply status between the heat pump device using the carbon dioxide refrigerant and the heat pump device using the hydrocarbon refrigerant.
